(19) United States
(12) Patent Application Publication
(10) Pub. No.: US 2018/0220830 A1
(43) Pub. Date: Aug. 9, 2018

(54) HEAT CONSERVING POT SUPPORT AND METHOD OF USING FOR STOVES

(71) Applicant: Mainstream Engineering Corporation, Rockledge, FL (US)

(72) Inventors: Andrew L. Carpenter, Rockledge, FL (US); Alex D. Paulsen, Rockledge, FL (US); Tyler Kunsa, Rockledge, FL (US); Paul E. Yelvington, Rockledge, FL (US)

(73) Assignee: Mainstream Engineering Corporation, Rockledge, FL (US)

(21) Appl. No.: 15/423,630

(22) Filed: Feb. 3, 2017

(51) Int. Cl. A47J 27/00; A47J 36/02; A47J 36/00

(52) U.S. Cl. CPC A47J 27/002; A47J 36/00; A47J 36/02

(57) ABSTRACT

A pot support and method of use are disclosed for improving the efficiency at fuel-fired cookstoves. Heat transfer to a cooking vessel is improved by directing hot exhaust gases along the outer walls of a cooking vessel by providing a vertical lip at the outer edge of the pot support that lends to an improvement in cookstove thermal efficiency.

### STATEMENT REGARDING FEDERALLY SPONSORED RESEARCH OR DEVELOPMENT

This invention was made with Government support under grant 2R44ES022880-02 awarded by the National Institute of Health, National Institute of Environmental Health Sciences. The Government has certain rights in the invention,

### BACKGROUND AND SUMMARY OF THE INVENTION

The present invention is directed to an apparatus and method of use that improve heat transfer to cooking vessels used with a fuel-fired cookstove. Particularly, the present invention is concerned with the configuration of the top section of a cookstove for improving cookstove thermal efficiency by directing hot gases exiting the cookstove along the typically vertical outer walls of a cooking vessel, thereby improving heat transfer. This top section of the stove is referred to interchangeably herein as the “drip pan” or “pot support” because it also optionally serves the purposes of collecting food drippings and supporting a pot or other cooking vessels.

A significant percentage of the world's population, estimated at 2.5 billion people, regularly cooks with biomass fuels such as wood or charcoal. In many countries, the demand for firewood outpaces forest regrowth, leading to deforestation. Additionally, emissions from biomass cookstoves contribute to global climate change, increase indoor air pollution, and are harmful to human health. Exposure to high indoor air pollutant levels from cooking with biomass fuels is responsible for an estimated 1.6 million deaths annually and about 3% of the global burden of disease. As such, it is important to improve fuel efficiency in order to reduce both deforestation and harmful combustion emissions.

The most basic cookstove is the three-stone fire, which consists of cooking vessel balanced upon three stones of similar height, between which the fire is centrally located. Numerous stoves exist that improve fuel and combustion efficiency compared to the three-stone fire. Stove designs vary widely in size, shape, and material. At minimum, most stoves incorporate a combustion chamber, a length of chimney, and a pot support or drip pan upon which the cooking vessel rests. The pot support or drip pan may be embodied integrally with the stove or as a separate component.

Prior drip pans have been designed primarily as a surface for the cooking vessel to rest and a reservoir to catch overflowing liquids, preventing them from entering the chimney section and combustion chamber. The gap between the pot bottom and the drip pan is also the location where hot gases flow and transfer heat to the cooking vessel, primarily through convection.

Several biomass cookstoves designed to reduce harmful emissions and improve thermal efficiency without reference to the drip pan are found in the prior art. For example, U.S. Pat. No. 8,899,222 illustrates a biomass cookstove for reducing harmful emissions, and includes a two part combustion chamber, a fuel feeding grate, and an orifice ring.

Known pot supports and other similar articles of manufacture are typically designed to integrate with gas and electric stoves. They include both cooking vessel attachments and burner attachments aimed to either improve thermal efficiency or prevent tipping of cooking vessels. So-called “pot skirts” attach to the outside of the pot and direct exhaust flow through a gap between the pot and the pot skirt. Prior burner attachments also include designs that extend vertically along a cooking vessel's side, or designs that remain underneath the cooking vessel. U.S. Pat. No. 1,592,729 directs heat to the bottom of the cooking vessel for the dual purpose of avoiding waste of heat and shielding the handles of cooking vessels. U.S. Pat. Nos. 983,413 and 4,448,186 disclose arrangements that concentrate heat on the bottom of the cooking vessel while simultaneously providing ventilation for proper fuel combustion. U.S. Pat. No. 2,030,519 uses an inverted conical shape to uniformly heat the bottom of a cooking vessel. U.S. Pat. Nos. 8,020,550 and 7,703,452 describe cooking vessel attachments that prevent hot gases from traveling up the cooking vessel's face.

Prior to our invention, no one appears to have recognized that a lip incorporated into the pot support for directing hot gases up the side of the pat: would produce superior results. Indeed, the prior art suggested just the opposite by teaching that the use of a pot skirt that blocks the flow of hot gases from reaching the top portion of the pot and thereby creates a recirculation zone on the bottom portion of the pot. We recognized that a dramatic improvement over known types of cooking vessel attachments, stove attachments, and fuel-fired cookstoves could be achieved by directing hot, buoyant gases along the outer walls of a cooking vessel.

We further recognized that such an improvement was obtainable by providing a lip that directs hot exhaust gases such that convective heat transfer is increased along the sides of the pot, resulting in an overall enhanced stove thermal efficiency. As used herein “pot” means any cooking vessel. Likewise, thermal efficiency” is the fraction of chemical potential energy in the fuel that is transferred as heat to the contents of the cooking vessel. Improving thermal efficiency reduces the amount of fuel required to cook the same amount of food, leading to the following benefits: 1) less fuel/wood to gather or purchase, saving time and/or money and reducing deforestation: 2) fewer particulate matter emissions, improving health and living conditions; 3) fewer carbon dioxide emissions, reducing smog, climate change, and health effects.

More specifically, the present invention is directed to a pot support for use in fuel-fired cookstoves. In a currently preferred embodiment, the cookstoves are biomass-burning cookstoves, specifically of a so-called “rocket stove” configuration. The present invention accommodates, however, a variety of cooking traditions and implements. Angled feet can, for example, optionally accommodate a wide variety of cooking vessels, both large and small, round bottomed and flat bottomed, metallic and ceramic, without hindering gas flow through the stove or thereby reducing efficiency. The present invention also optionally includes a reservoir to catch any spilt or overflowing liquids that can extinguish the fire or soil the chimney or combustion chamber.

One advantage of our invention is that it is also easy to manufacture, whether by machining or casting. Specifically, the present invention is manufacturable via sand casting which is, importantly, a low-cost, less sophisticated method widely used in developing countries. Protrusions are minimized to ease the casting process and reduce cost. The pot support using the principles of the present invention is thin and lightweight, which in turn lowers manufacturing cost and reduces heat loss to the stove and the environment. A second advantage of our invention is that it can he made of cast iron. Cast iron is strong and durable, improving the lifetime of the present invention. Using cast iron also ensures manufacturing costs are kept low.

Further, the present invention involves a method that directs hot, buoyant gases exiting the stove along the outer walls of a cooking vessel. Gases exiting the stove chimney first impinge upon the bottom of a cooking vessel, directing gas flow radially outward and perpendicularly away from the cooking vessel. If left unobstructed as in the past, the hot gases would follow a path away from the cooking vessel, such that heat transfer from the hot gases to the cooking vessel occurs primarily at the cooking vessel's bottom. We recognized that this results in unnecessarily wasting heat still present in the hot gases that s available to heat the contents of the pot. The present invention redirects hot gases, which are travelling perpendicularly away from the cooking vessel, vertically along the sides of a cooking vessel. Redirecting the gas flow vertically in accordance with our invention by using a vertical lip at the outer edge of the pot increases the time in which the hot gas flow is in contact with the cooking vessel by creating a hot boundary layer flow along the vertical pot surface, thus improving heat transfer, decreasing cooking time, and increasing vessel temperature. The lip can take a variety of shapes and sizes depending upon the final stove configuration, but in all cases has a scooped circumferential-like feature that directs hot gases upwards rather than radially outwards.

An object of this invention, therefore, is to improve thermal efficiency of cookstoves, thereby reducing fuel usage, harmful emissions, and cooking times.

A further object of this invention is to integrate with buoyancy driven fuel-fired cookstoves, whether biomass or fossil-fuel fired.

Yet another object of this invention is to be simple to manufacture using preferably sand casting.

Yet another object of this invention is to allow cooking vessels to rest on protruding supports such that the flow of air through the stove is unhindered.

Yet another object of this invention is to direct flow of hot gases along the side of a cooking vessel by way of a predominantly vertical lip located at the outer circumference of the invention.

The present invention improves on the known variations of pot supports by directing exhaust flow to improve the thermal efficiency of cookstoves.

Other objects, advantages and novel features of the present invention will become apparent from the following detailed description when considered in conjunction with the accompanying drawings and non-limiting examples herein.

### BRIEF DESCRIPTION OF THE DRAWINGS

FIGS. 1A and 1B are, respectively, an exploded isometric view (on the left) and in-place view (on the right) of a solid-fuel fired cookstove displaying a cooking vessel situated atop the heat conserving pot support in accordance with the present invention.

FIG. 2 is an enlarged, fragmented, cross-sectional view of the top section of the assembly shown in FIGS. 1A and 1B.

FIG. 3A-3D are, respectively, enlarged, cross-sectional views of a prior art conventional pot support shape and three currently contemplated lip shapes of the present invention.

FIGS. 4A and 4B are, respectively, graphs of cooking vessel temperatures versus time over the course of boiling 5 liters of water for a cold start and a hot start.

### DETAILED DESCRIPTION OF THE DRAWINGS

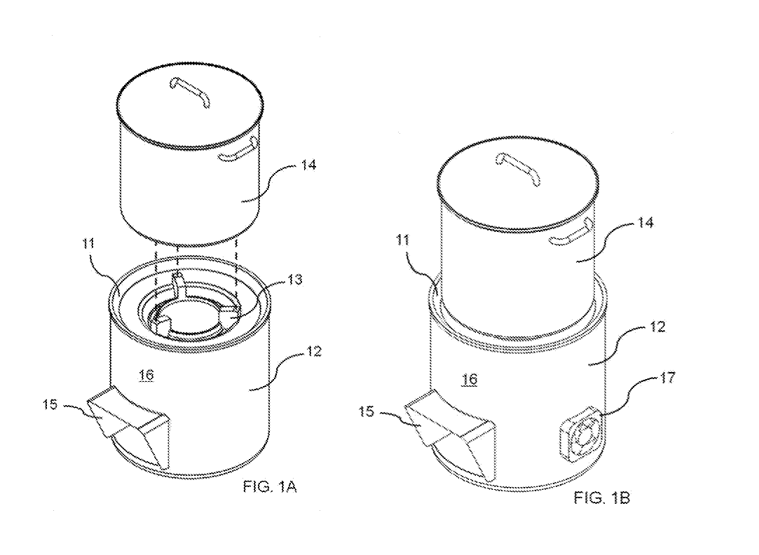

Now referring to FIGS. 1A and 1B, the pot support 11 is affixed to the top of a stove body 12. The method by which the pot support 11 is affixed to a stove body 12 can take many forms, including but not limited to, using rivets, screws, bolts, high-temperature adhesives, or metal joining. The pot support may be integral to the cookstove 16 or a separate, interchangeable component including a component that merely rests on the stove body 12. The pot support 11 includes one or more protruding structures 13 upon which a cooking vessel 14 rests. The pot support 11 can be configured to accommodate a variety of cooking vessels 14. In a currently preferred embodiment, the cooking vessel 14 is a pot. A typical cookstove 16 will contain a fire source, with fuel being fed to it through a fuel feed inlet 15. The fuel can be, a solid such as wood, charcoal, pellets, dung, agricultural residues and the like. Alternatively, the fuel can be liquid or gaseous fuels such as ethanol, kerosene, propane, white gas, and the like. The hot flue gases produced by such a fire are the primary mechanism by which the cooking vessel 14 is heated. The cooking vessel 14 sits atop the chimney section of the stove which directs hot flue gas from the combustion chamber up and out of the stove via buoyancy driven flow. Alternatively, the buoyancy driven flow of hot gases may be assisted through the use of a fan 17 built into the stove body 12 for providing forced air.

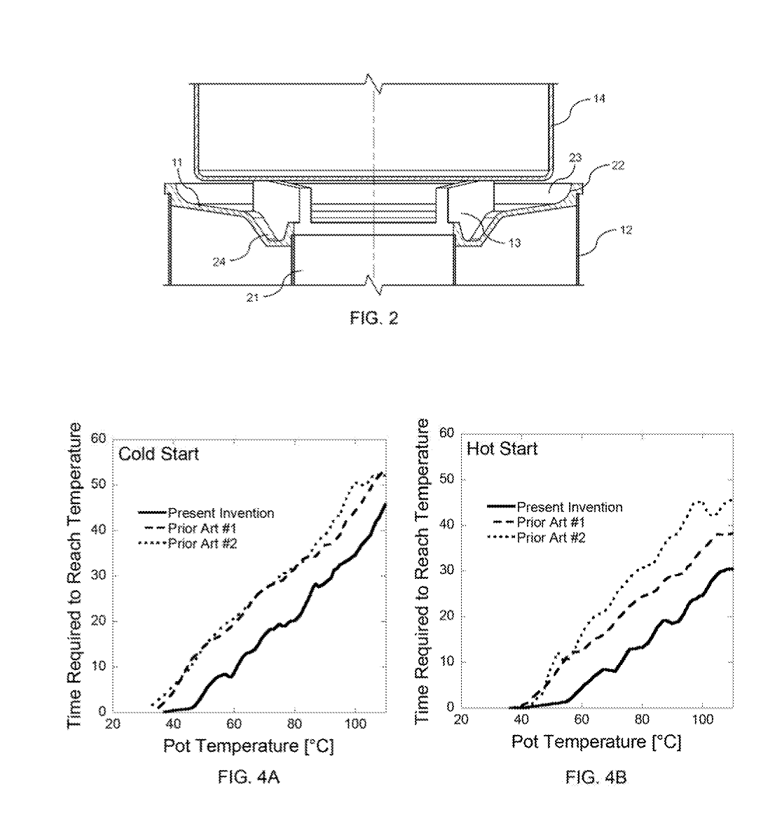

FIG. 2 shows an enlarged, fragmented, cross-sectional view of the top portion of the assembly shown in FIGS. 1A and 1B. One portion of the pot support 11 contains a reservoir 24 to catch any spilt or overflowing liquids that can extinguish the fire or soil the chimney or combustion chamber and another portion ends in a lip 22. The protruding structures 13 can be sized to extend above an upper horizontal edge of the lip 22 so that even oversized pots can be accommodated on the cookstove. The center of the pot support 11 aligns with the center of a stove chimney 21, which is housed within the stove body 12. During operation, a fire lit within the stove 16 causes hot gases to flow upwards through the chimney 21. These hot gases travel through the center of the pot support 11 and impinge upon the bottom of a cooking vessel 14. The hot gases then travel radially outward until they reach the edge of the cooking vessel 14, where the hot gases exit from a radial gap 23 formed between the bottom of the cooking vessel 14 and the pot support 11. One important aspect of the present invention is a circumferential lip 22 built into the outer edge of the pot support 11. When hot gases impinge upon the lip 22, the horizontal gas flow is forced into a vertical trajectory instead of being carried outward by its horizontal momentum as in the prior art which relied solely on buoyancy forces for the hot gases to rise along the outer walls of the vessel 14. As will be discussed below, positive redirection of the flow vertically improves heat transfer from the hot gases to the outer walls of cooking vessel 14, such that more energy is transferred to the cooking vessel 14 than if no lip 22 was present. The heat transfer is further improved by reducing mixing between the hot flue gases and ambient air, thereby increasing the gas temperature around the sides of the pot, which in turn increases convective heat transfer to the pot.

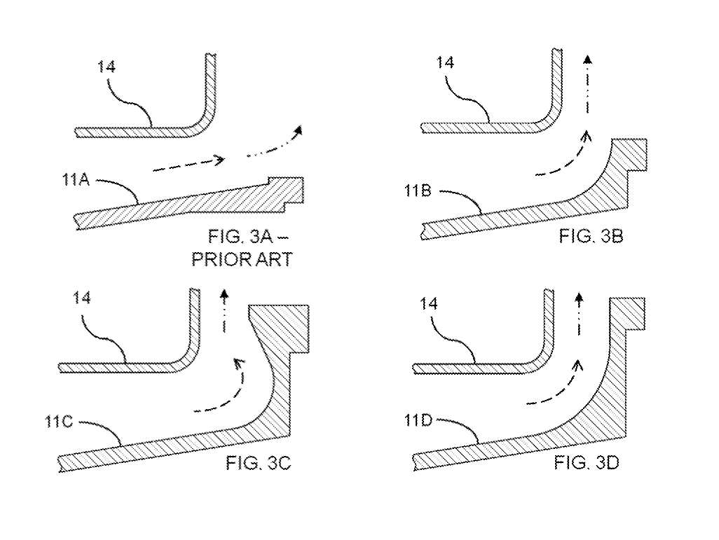

FIG. 3A shows an enlarged, fragmented, cross-sectional view of a conventional pot support shape with relation to the cooking vessel while FIGS. 3B-3D show various contemplated embodiments of the present invention. Dashed lines ending in an open arrow represent the initial bulk flow path of hot gases passing over the pot support 11. Dash-dot-dot lines ending in a closed arrow represent the approximate flow path of hot gases outside of the pot support 11 which are influenced by buoyancy and flow momentum at the exit of the interstitial gap between the cooking vessel 14 and the pot support 11.

FIG. 3A shows a conventional pot support 11A in relation to a cooking vessel 14. The initial gas flow is in a primarily horizontal direction flowing radially outward. By the time the buoyant force redirects flow vertically, the hot gas flow path has moved away from the side of the cooking vessel 14 and heat transfer to the cooking vessel 14 is diminished.

FIG. 3B, FIG. 3C, and FIG. 3D are illustrative examples of various embodiments the present invention. These examples are illustrative and non-limiting. In FIG. 3B, the pot support 11B directs hot gas flow vertically instead of horizontally. A similar design in FIG. 3D also shows the pot support 11D directing hot gas flow vertically where the height of the lip has been increased such that the bottom of the pot is below the lip. Additionally, the pot support 11C includes a narrowing gap so as to provide a nozzle feature that increases the exit velocity of gases through the gap into the ambient. In each case, the present invention ensures that hot gases remain in close proximity to the sides of the cooking vessel 14. This proximity increases heat transferred to the cooking vessel 14, which corresponds to increased thermal efficiency, decreased fuel consumption, decreased cooking times, and decreased emissions. The present invention has the advantage over pot skirts because the present invention does not require attachment of a separate device to the pot to achieve these effects.

### EXAMPLES

The following example is intended to be illustrative of the present invention and to teach one of ordinary skill how to make and use the invention. This example is not intended to limit the invention or its protection in any way.

### Example 1

### Measurement of Heat Transfer to a Pot

The present invention was compared to two commercially available pot supports. Each pot support, in turn, was fitted to a common rocket style wood burning cookstove stove. Tests were conducted using an abbreviated version of the Water Boil Test Version 4.2.2 developed by the International Organization for Standardization (ISO) as an International Workshop Agreement (IWA). Briefly, a pot containing five liters of water was placed on the cookstove, a wood fire was lit, and the pot was brought, to a boil while maintaining a constant fuel feed rate. This part of the test will hereafter be referred to as the “cold start”. After the water reached the boiling point, the fire was extinguished. The mass of the remaining water (after evaporation), the fuel consumed, and the remaining char was then measured and recorded. After finishing the cold start, the pot was refilled with fresh room-temperature water and a new fire was started. The water was again brought to a boil. This second part of the test is referred to as the “hot start”. After the water boiled during the hot start, the mass of the remaining water, the fuel consumed, and the remaining char was measured and recorded. During both the cold start and the hot start, thermocouples were used to measure the water temperature and the temperature halfway up the side of the pot.

A cold start followed by a hot start was performed twice for the present invention as well as two commercially available pot supports from the StoveTec GreenFire MK2 stove and the Envirofit G-3300 stove. Each of the three devices was secured to a common stove for testing so that all other variables, excluding the pot support design, were held constant. The pot temperature versus time for each of the pot supports is shown in FIG. 4A (cold start) and FIG. 4B (hot start). These figures clearly show that when operating a stove with the present invention the time required for the pot to reach 110° C. is significantly less than when operating the stove with either of the prior art pot supports installed. This can also be seen when comparing the time required to boil shown in Table 1 (Cold start) and Table 2 (hot start) where the present invention decreases boiling time by 5-10 minutes in comparison to either prior art pot support.

TABLE 1
Cold Start

| | | Thermal | Time to | Average Pot |
|---|---|---|---|---|
| | h | Efficiency | Boil | Temperature |
| Pot Support | [W/m2-K] | [%] | [min] | [° C.] |
| Present Invention | 237.1 | 20.1% | 49.5 | 82 |
| Prior Art #1 | 207.9 | 17.3% | 54.0 | 70 |
| Prior Art #2 | 199.4 | 14.0% | 59.0 | 71 |

TABLE 2
Hot Start

| | | Thermal | Time to | Average Pot |
|---|---|---|---|---|
| | h | Efficiency | Boil | Temperature |
| Pot Support | [W/m2-K] | [%] | [min] | [° C.] |
| Present Invention | 259.2 | 21.1% | 45.0 | 92 |
| Prior Art #1 | 248.0 | 18.2% | 42.0 | 74 |
| Prior Art #2 | 219.2 | 14.9% | 50.5 | 76 |

In addition to decreasing the time to boil, the present invention also improves the stoves thermal efficiency and increases the average pot temperature. The present invention is three percent more thermally efficient than the next best pot support (Prior Art #1, StoveTee GreenFire MK2). By improving efficiency, the present invention decreases fuel consumption which provides multiple user benefits. The present invention also increases the average pot temperature by 10-15° C. compared to the prior art pot supports, which explains why the present invention is more thermally efficient and quicker to boil water.

Heat transfer rate, q, to the pot is driven by three factors shown in Equation 1 below: the temperature difference between the pot and the hot gases in the freestream outside the thermal boundary layer ΔT=Tₛ−Tₓ; 2) the heat transfer coefficient h between the pot and the hot gases; and 3) the surface area of the pot.

q=hAΔT (1)

The pot surface area was constant between tests. The difference in heat transfer rate, q, can be attributed to changes in the heat transfer coefficient, h, and changes in the temperature difference, ΔT. Since the freestream temperature is not well defined here because the flue gas plume is mixing with ambient air, the freestream temperature was instead taken as the temperature of the hot gas exiting the stove through the gap, as is customary.

Heat transfer coefficients h were calculated using Equations 1 and 2. First, the heat transfer rate to the water, q, was calculated (Equation 2). Then, Equation 1 was solved for h with all other variables being known.

$$q = {mC}_{P} \frac{dT}{dt} + Δ {H}_{vap} \frac{d {m}_{vap}}{dt} \qquad ( 2 )$$

Table 1 and Table 2 both show that the present invention does indeed increase the heat, transfer coefficient between the pot and the hot gases exiting the stove. The average heat transfer coefficient was observed to increase by 14-18% during the cold start and 4-18% during the hot start by the addition of the lip feature on the pot support.

While we have shown and described several embodiments in accordance with our invention, it should be understood that the same is susceptible to further changes and modifications without departing from the scope of our invention. Therefore, we do not want to be limited to the details shown and described herein but intend to cover all such changes and modifications as are encompassed by the scope of the appended claims.

### Example 2

### Fluid Dynamics Simulations of the Gas Flow and Conjugate Heat Transfer

The present invention was compared to prior art from the Envirofit G-3300 stove using computational fluid dynamics simulations, which solve a numerical approximation to the Navier-Stokes equations across discrete elements in a computational domain. A two-dimensional cross section of each pot support geometry was modeled as an axisymmetric problem. The present invention and prior art simulations used identical material properties, boundary conditions, energy models, turbulence models, buoyancy effects, and solver methods to predict the conjugate heat transfer from the hot gas to the pot. The present invention increased surface heat flux to the outer wall of the pot in comparison to the prior art. Increased heat flux indicates improved heat transfer to the cooking vessel, which results in higher cookstove thermal efficiency. The simulation confirmed that improved heat transfer to the pot was the result of directing hot gas flow vertically along the cooking vessel. Although the simulations are an approximation to the complex, three-dimensional, turbulent flow around the stove, these results provide additional corroboration of the benefit provided by the present invention.

Although we have shown and described several embodiments of our invention, we do not intend to be limited to the details thereof but intend to cover all changes and modifications encompassed by our claims.

We claim:

1. A device for increasing cookstove efficiency, comprising a first portion configured to support a cooking vessel thereon and a second portion configured to direct hot gases from a cookstove under a bottom surface of the cooking vessel along a surface of the cooking vessel extending upwardly of the bottom surface.

2. The device of claim 1, wherein the first portion comprises a plurality of protrusions extending toward the bottom surface.

3. The device of claim 1, wherein the second portion has a lip-shaped configuration.

4. The device of claim 3, wherein the first portion comprises a plurality of protrusions extending toward the bottom surface and above an upper surface of the lip-shaped configuration.

5. The device according to claim 1, wherein the second portion forms a perimeter of the device with the first portion located inwardly of the perimeter.

6. The device of claim 1, wherein the second portions are arranged to define a gap therebetween to direct the hot gases along the upwardly extending surface of the cooking vessel.

7. The device of claim 6, wherein the gap is configured as a nozzle to increase velocity of the hot gases directed along the upwardly extending surface.

8. The device of claim 1, wherein the second portion is configured to direct the hot gases substantially only vertically.

9. The device of claim 1, wherein the second portion is configured with a lip that extends above the bottom surface.

10. The device of claim 1, wherein the first and second portions are comprised of sand-casted iron.

11. The device of claim 1, wherein the first portion contains a reservoir to catch liquids.

12. A cooking apparatus with improved efficiency, comprising one of a buoyancy-driven stove and a forced-convection stove, and a device having a first portion configured to support a cooking vessel thereon and a second portion configured to direct hot gases from a cookstove under a bottom surface of the cooking vessel along a surface of the cooking vessel extending upwardly of the bottom surface.

13. The cooking apparatus of claim 12, wherein the first portion comprises a plurality of protrusions.

14. The cooking apparatus of claim 12, wherein the second portion has a lip-shaped configuration.

15. The cooking apparatus of claim 14 wherein the first portion comprises a plurality of protrusions extending toward the bottom surface and above an, upper surface of the lip-shaped configuration.

16. The cooking apparatus of claim 12, wherein the second portion forms a perimeter of the device with the first portion located inwardly of the perimeter.

17. The cooking apparatus of claim 12, wherein the first and second portions are arranged to define a gap therebetween to direct the hot gases along the upwardly extending surface of the cooking vessel.

18. The cooking apparatus of claim 17, wherein the gap is configured as a nozzle to increase velocity of the hot gases directed along the upwardly extending surface.

19. The device of claim 11, wherein the first and second portions are comprised of sand-casted iron.

20. The cooking apparatus of claim 12, wherein the second portion is configured to direct the hot gases substantially only vertically.

21. The cooking apparatus of claim 12, wherein the second portion is configured with a lip that extends above the bottom surface.

22. The cooking apparatus of claim 12, wherein the first portion contains a reservoir to catch liquids.

23. A method of using the device of claim 1, comprising placing the device on a stove that employs one of wood, agricultural residue, grass, dung, gas, coal, charcoal, and liquid fuel.
